(19) United States
(12) Patent Application Publication
(10) Pub. No.: US 2002/0064614 A1
(43) Pub. Date: May 30, 2002

(54) Wc-disposable articles

(76) Inventor: Christopher Stratton Turnbull, Hythe (GB)

Correspondence Address: LAW OFFICES OF LOUIS WOO, 1901 North Fort Myer Drive, Suite 501, Arlington, VA, 22209, US

(21) Appl. No.: 09/985,102

(22) Filed: Nov. 1, 2001

(30) Foreign Application Priority Data
Nov. 28, 2000 (GB) 0029030.4

(51) Int. Cl. B32B 1/02

(52) U.S. Cl. 428/35.4

(57) ABSTRACT

A wc-disposable ostomy bag is made from an alkali-disposable sheet comprising an outer layer of a non-woven material, an inner, thin layer of an alkali-resistant material and an intermediate layer of an alkali-soluble material such as carboxylated acrylic polymer. The alkali-resistant material has a high odor barrier and may be of polyvinylidene chloride. The non-woven material comprises fibers retained with one another by a colored alkali-soluble binder sprayed onto the fibers to form discontinuous regions of binder.

### BACKGROUND TO THE INVENTION

This invention relates to wc-disposable articles.

There are several important criteria that must be satisfied by an ostomy bag. It must be highly odour proof over the entire period for which it is worn and in all circumstances of varying temperature and humidity etc. The bag should be inconspicuous from outside the wearer's clothing. For this reason, the bag material must not rustle or make other noises when the wearer moves. The bag should also be thin and flexible so that it conforms to the wearer's anatomy without producing bulges or ridges beneath the clothing. The bag must be reliable and secure so that the wearer can have high confidence that the bag will not tear or come apart at the edge seal during use. The bag should also be comfortable to wear.

Attempts have been made recently to develop ostomy and urine bags which can be disposed of by flushing in a wc, to avoid the need to make special disposal arrangements, which can be inconvenient, embarrassing and unhygienic.

Where a bag is also required to be wc disposable, this adds further difficulties to the choice of materials and manufacturing techniques, since the bag must possess all the above properties whilst also being capable of being disposed of by flushing in a wc. The problems are further compounded if the bag must be resistant to water, so that it can be worn safely in wet conditions. The selection of appropriate combinations of different materials that enables a bag to satisfy these requirements requires considerable skill and experiment.

WC-disposable bags have been proposed in the literature, the bags having an outer water-soluble or dispersible layer and an inner water-resistant layer. The outer layer provides mechanical support for the inner layer so that, when the bag is dropped into turbulent water in a wc pan, the outer layer is quickly broken up. The inner layer prevents the contents of the bag attacking the outer layer in use but, once the outer layer is broken up on disposal, the inner layer does not have sufficient mechanical strength in itself to cause blockage on flushing the wc An example of such a bag is described in GB 2083762B. A wc-disposable bag is sold by Portex Limited, England under the name Symphony (Symphony is a Registered Trade Mark of Portex Limited).

Although such bags can be used satisfactorily, the fact that the outer layer is damaged by contact with water means that the user has to take special precautions to ensure that the outside of the bag does not become wet. This can be especially inconvenient with bags which are worn long-term, for two or more days, such as is usually the case with ileostomy bags. The use of such bags can make washing difficult and prevents the user swimming.

An alternative form of bag is described in EP 0142950A, which is made of 3-hydroxybutyrate film, either in a laminate with a water-soluble film as an outer layer, or entirely from 3-hydroxybutyrate. Such a material remains intact when in contact with water or body waste, but is broken up if the pH is raised to about 12. The bag described is disposed of by adding a base material to the contents of the bag so as to raise the pH of the contents to at least 12 so that it breaks up when agitated in a wc pan. The laminated construction would not avoid the disadvantages referred to above of having to keep the outside of the bag dry. Furthermore, 3-hydroxybutyrate does not provide sufficient odour barrier properties to be useful in a practical bag.

A further alkali-disposable bag is described in GB 2195919B. The walls of this bag have a central layer of polyvinyl alcohol, an inner layer of a blend of polyvinylidene chloride acrylonitrile copolymer with carboxylated acrylic copolymer, and an outer layer of two or more coatings of carboxylated acrylic acid. This bag can be disposed of in a wc by adding an alkali to the water in the pan. The material proposed for the inner layer combines the alkali-solubility of carboxylated acrylic copolymer with the high odour barrier properties of polyvinylidene chloride acrylonitrile copolymer, the blend being water resistant. However, in practice it has been found difficult to produce an inner layer having sufficiently high odour barrier properties whilst also being broken up quickly in alkali. Furthermore, the polyvinyl alcohol central layer is difficult to coat because the high resistance of polyvinyl alcohol to organic solvents produces a weak interply adhesion. Attempts to use an aqueous-based coating material have not been entirely satisfactory because the polyvinyl alcohol abstracts the water from the coating too quickly to enable a high quality film to be produced. Although it is possible to produce bags according to GB 2195919B that will function, their speed of disposability and odour barrier properties are not as good as would be desired.

Another alkali-disposable bag is described in GB 2257056. This bag has an outer layer substantially entirely of alkali-soluble/water-insoluble carboxylated acrylic polymer forming a major part of the thickness of the material and a thinner, inner layer of alkali-resistant polyvinylidene chloride bonded directly to one side of the first layer. One problem with this bag is that the outer layer can in some cases become softened by the warmth and humidity of the wearer's body, causing the bag to be deformed by its weight and that of its contents. This can lead to damage to the inner layer and leakage of odour. GB 2324761 describes an alkali-disposable bag made from a similar wall material with an additional outer layer of a non-woven material. This outer layer is made up of fibres, which may be held together by a binder of an alkali-soluble material. It has been found, however, that this additional layer may be rather stiff, thereby making the bag itself less flexible and so making it less comfortable and more conspicuous. The additional stiffness can also make a partially broken up bag less easy to flush. Also, the time to break up the bag sufficiently for flushing may be longer than ideal.

A further problem with wc disposable bags is that it may not be easy to determine when the bag has been broken up sufficiently to enable it to be flushed away safely. The time the bag has to remain in the wc pan before flushing can vary according to water temperature and the volume of water in the pan. GB 2324761 describes a bag having a dye incorporated into it that colors the water in the pan as it breaks up. US 5578023 describes a bag with a legend printed on it that is concealed under a panel of soluble material so that the legend becomes visible as the bag breaks up.

Similar problems exist with other forms of wc-disposable articles, such as diapers and sanitary towels.

### BRIEF SUMMARY OF THE INVENTION

It is an object of the present invention to provide an alternative wc-disposable article.

According to one aspect of the present invention there is provided a wc-disposable article including an alkali-disposable sheet having an outer layer of a non-woven material, the non-woven material comprising fibres retained with one another by discontinuous regions of an alkali-soluble binder.

The alkali-disposable sheet preferably comprises a layer of an alkali-soluble material and a layer of an alkali-resistant material on a side of the alkali-soluble layer opposite the non-woven layer, the layer of alkali-resistant material being thin compared with the layer of alkali-soluble material. The alkali-soluble material may be carboxylated acrylic polymer. The alkali-resistant material preferably has a high odour barrier. The alkali-resistant material may be polyvinylidene chloride. The binder may include a coloring substance such that the color of the outer layer changes as the article is broken up in the wc.

According to another aspect of the present invention there is provided a wc-disposable article including a wc-disposable sheet having an outer layer of a non-woven material, the non-woven material comprising fibres retained with one another by a dispersible binder colored with a substance such that the color of the outer layer changes as the article is broken up in the wc.

The binder may be colored with a substance including iron oxide. The binder may be an aqueous polyacrylate dispersion and may be applied to the fibres by spraying.

According to a further aspect of the invention there is provided a bag according to the above one or other aspect of the invention including two walls of the sheet arranged with their layers of non-woven material facing outwardly.

An ostomy bag according to the above further aspect of the invention preferably includes an opening in one of the walls and means for attaching the bag around the opening to the skin around a stoma.

A wc-disposable ostomy bag and its method of manufacture, in accordance with the present invention, will now be described, by way of example, with reference to the accompanying drawings.

### BRIEF DESCRIPTION OF THE DRAWINGS

FIG. 1 is a front elevation view of the ostomy bag;

FIG. 2 is a sectional side elevation along the line II-II of FIG. 1; and

FIG. 3 is a section through the wall of the bag.

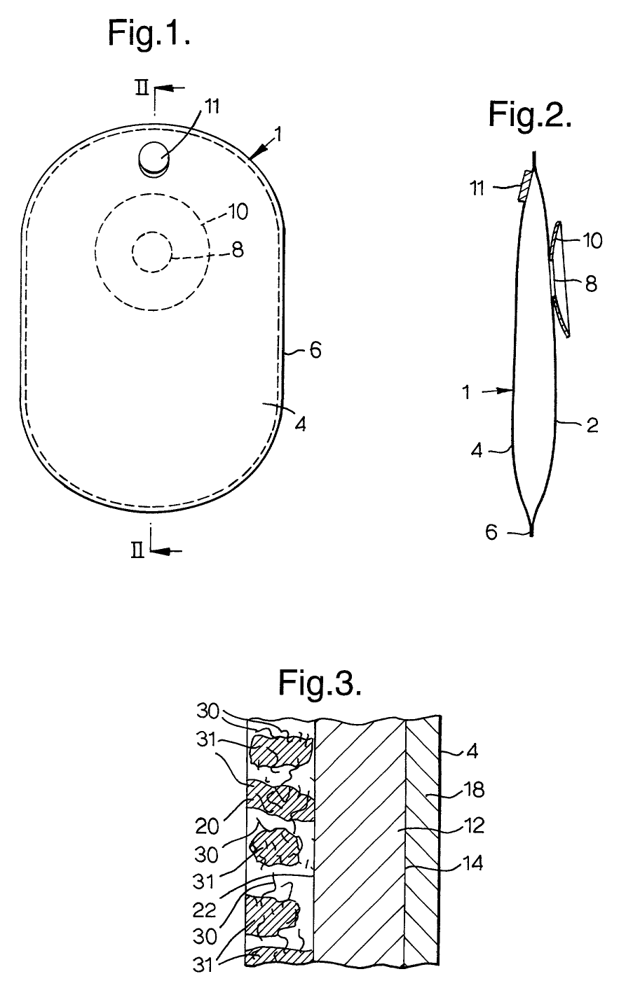

### DETAILED DESCRIPTION OF THE PREFERRED EMBODIMENT

The ostomy bag 1 is of conventional shape and comprises two walls or sheets 2 and 4 of the same material heat sealed together around their outer edge 6. The sheet 2, which, in use, faces the wearer, has an orifice 8 forming an opening to the bag. An adhesive flange 10 is secured to the sheet 2 around the orifice 8; this serves to secure the bag to the user's skin around the stoma so that fecal matter is discharged into the bag. A filtered vent 11 is located towards the top of the bag 1.

The material from which both sheets 2 and 4 are made is shown in greater detail in FIG. 3. FIG. 3 does not show the relative thickness of the layers to a correct scale. The sheets 2 and 4 comprise three layers. A first continuous, imperforate layer 12 is of carboxylated acrylic polymer of the kind sold by Belland AG under Grade No. 100H40LB. Typically, the layer 12 is about 100 micron thick. One surface 14 of the layer 12 has a coating in the form of a continuous, imperforate second layer 18 of polyvinylidene chloride, which is about 2-3 micron thick, that is, thin compared with the layer 12. The second layer 18 is presented inwardly to the contents of the bag 1 on both sheets 2 and 4. Because polyvinylidene chloride provides a very effective odour barrier, it is only necessary to use a very thin layer, even though the layer 12 of carboxylated acrylic polymer has very poor odour barrier properties.

The third layer 20 is formed on the opposite surface 22 of the layer 12 and is of a nonwoven material with a thickness equivalent to about 30 gsm. The nature of the non-woven material forming the third layer 20 is selected to provide stability to the underlying layer 12 when dry but to break down when wetted by an alkaline solution. The non-woven material comprises a mass of fibres 30 held together by regions 31 of an alkali-soluble binder. The non-woven fibres 30 could be formed from a wide range of polymers, or blends of different types, such as cellulose and polyester. The alkali-soluble binder 31 could be of various kinds, such as aqueous polyacrylate dispersions, for example, that available from Belland AG under the reference DBC 2620. The binder 31 also incorporates a colored substance that causes the color of the bag to change as it breaks up. The substance is preferably a pigment such as iron oxide in an aqueous base, which gives the bag an overall skin color.

The binder is applied to the non-woven material 20 in a manner that produces spots or other discontinuous regions 31 of binder over the layer, as illustrated in FIG. 3. For example, the binder could be sprayed onto a mat of the non-woven fibres 30 so that droplets of binder penetrate as spots 31 into the fibre mass, the amount of binder sprayed being insufficient for the spots to combine into a continuous layer. This arrangement has several advantages. First, it enables the non-woven layer 20 to be substantially softer and more flexible than it would be if the layer were immersed in binder solution and this formed a continuous region of binder. This is an advantage because it makes the bag itself more flexible and comfortable to wear and it follows the contours of the anatomy more closely, making it less conspicuous under clothing. Also, it reduces the time taken for the outer layer to be broken up because the overall amount of binder employed is reduced and because the regions of binder are exposed for attack by the alkali over a greater surface area. The regions of non-woven material between those coated with binder allow penetration of water vapour, so that the bag feels less clammy against the skin, and also allows alkali in the wc water to attack the underlying layers 12 and 18 of the bag more quickly.

To manufacture, the layer 18 is coated onto the layer 12. The non-woven layer 20 is then applied to the coated layer 12 either by laminating with the use of an adhesive or simply by welding around its edge when the front and rear walls 2 and 4 of the bag are joined together. In the latter arrangement the non-woven layer 20 is only attached around its edge.

The bag is made by cutting sheets 2 and 4 from the material and placing them with their polyvinylidene chloride layers 18 facing one another prior to heat sealing them together around their outer edge 6. The good interply adhesion between the layers 12 and 18 ensures that the weld strength of the seal around the edge 6 of the bag is high. The flange 10 may then be attached by an adhesive.

The bag 1 is used in the conventional way. The outer, non-woven layer 20 keeps the plastics layer 12 away from direct contact with the patient's skin, thereby reducing its exposure to perspiration. Water vapour, however, can pass through the outer layer 20 to the underlying layer 12 and this, combined with the warmth of the body may lead to some softening of the central layer. The outer layer 20, however, provides a mechanical reinforcement to the central layer 12, thereby increasing its structural integrity and preventing it being stretched or deformed by the weight of the bag and its contents. This is important because the inner layer 18 is very thin and any deformation in the bag 1 could cause ruptures in this layer, leading to the escape of odour.

The material of the sheets 2 and 4 is flexible and noise free so that the bag lies flat and remains inconspicuous under clothing. The outer non-woven layer 20 increases comfort to the patient compared with imperforate polymeric films. The bag can be worn safely while washing, swimming or undertaking similar activities where the outside of the bag may become wet.

When the bag is full, it is removed from the body and closed by folding the adhesive flange 10 in half about its vertical diameter; excess air is expelled by squeezing through the vent 11. The user adds a quantity of a chemical to the water in the wc pan which is sufficient to raise the pH of the water to about 10. The preferred chemical is a mixture of triethanolamine (a water-soluble alkali) and a surfactant such as an ionic surfactant containing sodium dioctyl sulphosuccinate (eg Aerosol OT75 —Aerosol is a Registered Trade Mark of Cyanamid) in the ratio 5:1 by weight. The pH of this composition is 11.5 and, when diluted to 0.5% weight-weight in water, it has a pH of 10 at 15 degrees Centigrade. The undiluted additive is, therefore, not too active to be dangerous to the user but needs only to be added in relatively small quantities to the wc pan to be effective. The alkaline mixture is preferably in the form of a liquid which may be added to the wc pan from a bottle, syringe, sachet or similar container. Alternatively, alkalis in the form of powders or tablets can be used which are dissolved on contact with water in the wc pan.

The bag 1 is then dropped into the wc pan so that the outer surface of the bag is contacted by the alkali and water mixture. It will be appreciated that a large proportion of the bag surface quickly becomes wetted by the surfactant and alkali, which starts to disperse the binder 31 and break up the non-woven layer 20 and the underlying layer 12. As the colored binder 31 in the non-woven layer disperses, the appearance of the bag clearly changes in that it loses its pinkish skin color and becomes pale. When this happens it is clear to the user that the bag has been broken up sufficiently for it to be flushed away safely. The amount of pigment used in the binder is such as to give the desired color change to the bag but without substantially altering the color of the water in the wc. It will be appreciated that the colored binder could be used in conventional wc-disposable articles, not just those requiring the addition of an alkali.

The inner layer 18 is not affected by either water or alkali but it is so thin that, once it loses the structural support of the other layers 12 and 20, it has insufficient strength by itself to present an obstacle to flushing.

Flushing of the wc agitates the water in the pan helping further to break up the inner layer 18 or force it into more intimate contact with the bag contents. Any residual gas in the bag 1 escapes through the vent 11 or through ruptures in the bag as the wc is flushed, thereby allowing the contents of the bag and the remains of the bag itself to be flushed away without blockage. The increased flexibility of the outer layer 20 means that any remaining parts of the outer layer present less of an obstacle to flushing.

The flange 10 is wc disposable and, in this respect may be of a material that becomes limp on contact with water and is of a suitable size that it is readily flushed away. For additional security, the flange could be water resistant but alkali disposable. Alternatively, the flange could be removed before the bag is placed in the wc pan.

Similar non-woven materials could be used in other wc-disposable articles, such as diapers and sanitary towels.

What I claim is:

1. An article made of an alkali-disposable sheet material, said sheet material comprising an inner layer and an outer layer, said outer layer being a non-woven material, and said non-woven material comprising fibres retained with one another by discontinuous regions of an alkali-soluble binder.

2. An article according to claim 1, wherein said inner layer comprises a layer of an alkali-soluble material and a layer of an alkali-resistant material, said layer of alkali-resistant material being on a side of said alkali-soluble layer opposite said outer layer, and wherein said layer of alkali-resistant material is thin compared with said layer of alkali-soluble material.

3. An article according to claim 2, wherein said alkali-soluble material is carboxylated acrylic polymer.

4. An article according claim 2, wherein said alkali-resistant material has a high odour barrier.

5. An article according to claim 2, wherein said alkali-resistant material is polyvinylidene chloride.

6. An article according to claim 1, wherein said binder includes a coloring substance such that the color of said outer layer changes as the article is broken up by an alkali.

7. An article according to claim 1, wherein said binder is an aqueous polyacrylate dispersion.

8. An article according to claim 1, wherein said binder is applied to said fibres by spraying.

9. A wc-disposable article of a wc-disposable sheet material, said sheet material comprising an inner layer and an outer layer, said outer layer being of a non-woven material, said non-woven material comprising fibres retained with one another by a dispersible binder colored with a substance such that the color of said outer layer changes as said article is broken up in a wc.

10. An article according to claim 9, wherein said binder is colored with a substance including iron oxide.

11. Alkali-disposable sheet material comprising: a first layer of an alkali-soluble material;
a second layer on one side of said first layer, said second layer being of a water-resistant material and being thin compared with said first layer; and a third layer on a side of said first layer opposite said second layer, said third layer being formed of fibres retained together by spots of an alkali-dispersible binder.

12. An ostomy bag comprising: a front wall; a rear wall; an opening into the bag through said rear wall; and a flange secured with said rear wall around said opening by which said bag can be attached to a patient's skin, wherein said walls are of an alkali-disposable sheet material, said material having an inner layer presented inwardly of the bag and an outer layer, wherein said outer layer is of a non-woven material, and wherein said non-woven material comprises fibres retained with one another by discontinuous regions of an alkali-soluble binder, such that the bag can be disposed of in a wc to which an alkali has been added.

13. An ostomy bag comprising: a front wall; a rear wall; an opening into the bag through said rear wall; and a flange secured with said rear wall around said opening by which said bag can be attached to a patient's skin, wherein said walls are of a wc-disposable sheet material, said material having an inner layer presented inwardly of the bag and an outer layer, wherein said outer layer is of a non-woven material, and wherein said non-woven material comprises fibres retained with one another by a dispersible binder including a coloring substance such that the color of said outer layer changes as the bag is broken up in a wc.
